(19) United States
(12) Patent Application Publication
(10) Pub. No.: US 2012/0115510 A1
(43) Pub. Date: May 10, 2012

(54) GEOLOCATION OF A MOBILE STATION OF A WIRELESS TELEPHONY NETWORK

(75) Inventors: Bruce Denby, Paris (FR); Gérard Dreyfus, Gif Sur Yvette (FR); Yacine Oussar, Paris (FR); Iness Ahriz, Paris (FR)

(73) Assignee: UNIVERSITE PIERRE ET MARIE CURIE (Paris 6), Paris (FR)

(21) Appl. No.: 13/377,642

(22) PCT Filed: Jun. 4, 2010
(86) PCT No.: PCT/EP10/57859

§ 371 Date: Dec. 12, 2011

(30) Foreign Application Priority Data
Jun. 12, 2009 (FR) 0902863

(51) Int. Cl. H04W 24/00

(52) U.S. Cl. 455/456.1

(57) ABSTRACT

The disclosure relates to a method for locating a mobile station inside an area covered by a wireless telephony cellular network in which the mobile station operates. The method includes using the mobile station to measure the received power on at least seven different communication channels of the network (step 200) and then locating the station according to the measurements and relevant predetermined information of the correspondence between received power on the channels and location within the covered area. The predetermined information can include power levels previously measured on the channels at different locations and stored in a database, in which case the station is located by comparing the measurements with the contents of the database. The method also enables greater locating accuracy, even inside buildings.

### CROSS-REFERENCE TO RELATED APPLICATIONS

This application is a National Phase Entry of International Application No. PCT/EP2010/057859, filed on Jun. 4, 2010, which claims priority to French Patent Application Serial No. 0902863, filed on Jun. 12, 2009, both of which are incorporated by reference herein.

### BACKGROUND AND SUMMARY

The present invention relates to the field of geolocation, more particularly the geolocation of a mobile station operating in at least one wireless telephony network. It may be desirable to be able to precisely locate a person or objects, whether outside or inside buildings.

Systems for locating mobile stations from wireless signals in a cellular network have already been proposed. These mobile station location systems are in particular implemented for locations in outdoor environments. These systems, however, locate a mobile station to within the reach of its attachment cell. These systems are therefore relatively imprecise.

It is, however, possible to obtain better precision of these systems, by comparing the closest base station signals (“fingerprint” method). The precision thus obtained remains low, however, since it is in the order of a hundred meters. Such imprecision is of course incompatible with localization inside buildings, aiming to determine in what room of the building the mobile station is located. Thus, the adaptations of such systems to localization inside buildings are not fully satisfactory.

Furthermore, mobile stations are known equipped with a global positioning receiver associated with a global positioning system (GPS). This GPS receiver is adapted to receive satellite-diffused radioelectric synchronization signals. These signals allow the receiver to determine its location (longitude, latitude and altitude), irrespective of the meteorological conditions.

The GPS receiver of a motor vehicle is also generally adapted to implement a so-called “dead reckoning” method. Such a method makes it possible to locate the vehicle even when it is in a tunnel or urban environment, where the number of satellites is insufficient to locate the vehicle using only the reception of the signals broadcast by the satellites. Such a dead reckoning method estimates the position of the motor vehicle from location data previously received from satellites.

A “pedestrian” mode is generally available on the GPS receivers. This “pedestrian” mode extends the GPS service to the location of persons. However, the precision of this “pedestrian” mode is clearly less satisfactory. A pedestrian indeed moves much more slowly than a vehicle. Furthermore, a pedestrian is likely to stay longer—sometimes even permanently—in areas not allowing good reception of the signals transmitted by the satellites. This is in particular true inside buildings. In such a case, the synchronization of the GPS receiver with the satellites is quickly lost. The location precision is greatly deteriorated relative to the precision that can be obtained in an area well covered by the GPS satellites. Furthermore, the GPS system does not provide any information on a person's position inside a building.

Systems also exist for localization in enclosed environments using radio waves implemented in Wi-Fi networks (defined by the IEEE 802.11 standards). The “fingerprint” method is also implemented in this type of system. The Wi-Fi access points in fact play the role of cellular base stations. Precisions of about 2 meters were cited in the literature for localization in the hallways of large commercial buildings equipped with several Wi-Fi access points.

However, Wi-Fi does not lend itself well to household environments, storage warehouses, etc. In fact, Wi-Fi networks are less common, less dense when they are deployed. These Wi-Fi networks can vary quite a bit from the perspective of access point positioning. Furthermore, the frequency used in Wi-Fi (2.4 GHz or 5 GHz depending on the case) does not lend itself to good localization, as the signals in that frequency range are too weakened by the partitions found in the buildings. The systems implemented in the Wi-Fi networks also imply that the person or object to be located has a Wi-Fi compatible device. This is rarely the case.

There is therefore a need for a localization method that is easy to implement while being effective and precise in all locations, and in particular inside one or more buildings. To that end, according to a first aspect, the invention proposes a method for supplying information that can be used to locate a mobile station within a given area covered by at least one wireless telephony cellular network in which the mobile station operates, the method comprising:
for one or more given locations within the given area, providing, for each of the given locations, at least one set of N values, each of the values corresponding to a measured reception power level on a respective channel among N different predetermined communication channels of the at least one wireless telephony cellular network, N being a fixed integer greater than or equal to 7; and
creating a first database associating each set of N values with the corresponding given measurement location.

According to a first preferred embodiment, the method also comprises:
for each one among the one or more given locations within the given area, defining a set of R predetermined values that is specific to that given location, R being an integer greater than or equal to 1, this set of R predetermined values being associated with each set of N values provided for the corresponding given location in the first database; and
determining, by statistical learning from the first database, a set of R functions that can provide, from each set of N values, a set of R values that is an approximation of the set of R predetermined value(s) associated with said set of N values.

According to a second preferred embodiment, the method also comprises:
providing Q different function(s), Q being an integer greater than or equal to 1 and less than N, and
creating a second database from the first database by applying, to each set of N values, the Q function(s) to provide a corresponding set of Q value(s), the set of Q value(s) being associated in the second database with the corresponding given measurement location,
   wherein the Q function(s) are chosen so that, for any pair of sets of N different values of the database, the two sets of Q values obtained by applying those Q functions to that pair of sets of N values are different from one another. It is advantageous for the Q function(s) to be provided either through an analysis of primary components, or through an analysis of independent components, or for the Q function(s) to respectively provide the average value, standard deviation, and other higher-order moments of the set of N values. Furthermore, it is advantageous for the method to comprise:
for each one among one or more given locations within the given area, the definition of a set of R predetermined value(s) that is specific to that given location, R being an integer greater than or equal to 1, this set of R predetermined value(s) being associated with each set of Q values provided for the corresponding given location in the second database; and
determining, by statistical learning from the second database, a set of R function(s) that can provide, from each set of Q value(s), a set of R value(s) that is an approximation of the set of R predetermined value(s) associated with said set of Q value(s).

According to a third preferred embodiment, the method comprises, for each given location, the determination, by statistical learning from either the first database or the second database, of a function able to provide, respectively from the set of N values or the set of Q value(s) obtained by applying the Q function(s) to the set of N values, an estimate of the probability that the measurement was done in that given location.

According to a second aspect, the invention proposes a method for locating a mobile station within a given area covered by at least one wireless telephony cellular network in which the mobile station operates, the method comprising the steps of:
a) measurement by the mobile station of the received power level on each channel among N different predetermined communication channels of the at least one wireless telephony cellular network, N being an integer greater than or equal to 7, and
b) location of the mobile station based on the levels measured in step a) and relevant predetermined information on the correspondence between received power level on each of the N channels and location within the given area.

According to one preferred embodiment, it is provided that for one or more given locations within the given area, the predetermined information comprises, for each given location, at least one associated set of W predetermined value(s) that is relevant on a received power level on each of the N channels in the corresponding given location, W being an integer greater than or equal to 1; and step b) comprises locating the mobile station by analyzing the levels measured in step a) relative to the set(s) of W predetermined value(s). It can be provided that W is equal to N, the W predetermined values of each set each being representative of a received power level on a respective channel among the N channels; and the analysis in step b) comprises the comparison of the levels measured in step a) with the set(s) of W predetermined values. In this case, the set(s) of W predetermined value(s) can be the set(s) of N values from the first database created using the information supply method according to the first aspect of the invention defined above.

Alternatively, it may be provided for W to be less than N, in which case the analysis in step b) comprises:
(i) applying W different predetermined function(s) to the levels measured in step a) to provide a set of W value(s) that is relevant of the levels measured in step a) homogenously with the set(s) of W predetermined value(s); and
(ii) comparing the set of W value(s) thus provided with the set(s) of W predetermined values.
   In this case, the set(s) of W value(s) and the W predetermined function(s) can be those provided, created, respectively, according to the second embodiment of the information supply method according to the first aspect of the invention.

According to another preferred embodiment, the predetermined information comprises, for each one among one or more of the given locations within the given area, an associated set of R predetermined value(s) that is specific to that given location, R being an integer greater than or equal to 1, and a set of R predetermined function(s) provided to supply, from the received power levels measured at any given location on the N channels and after any pre-processing of those measured levels, a set of R value(s) that is an approximation of the set of R predetermined value(s) corresponding to that given location. Furthermore, step b) comprises: (i) providing a set of R value(s) using the set of R predetermined function(s) from the levels measured in step a) and preprocessed, if applicable; and (ii) locating the mobile station by comparing the set of R supplied value(s) with the set(s) of R predetermined value(s).

According to still another preferred embodiment, the predetermined information comprises a set of R predetermined function(s) provided to supply, from received power levels, measured at any location within the given area, on the N channels and after any preprocessing of those measured levels, a set of R value(s) that is an approximation of the coordinates of the measurement location, and step b) comprises: (i) providing a set of R value(s) using the set of R predetermined function(s) from the levels measured in step a) and preprocessed if necessary; and (ii) locating the mobile station at the coordinates expressed by the set of R value(s) provided. According to still another preferred embodiment, the predetermined information comprises a set of R predetermined function(s) provided to supply, from the received power levels, measured at any location within the given area, on the N channels and after any preprocessing of said measured levels, a set of R value(s) that is an approximation of the reference of the measurement location in a location referencing system within the given area; and step b) comprises: (i) supplying a set of R value(s) using the set of R predetermined function(s) from the levels measured in step a) and preprocessed if applicable; and (ii) locating the mobile station at the location reference approximated by the supplied set of R value(s). In these different embodiments in which the predetermined information comprises a set of R predetermined function(s), this set of R predetermined function(s) can be determined by implementing the first embodiment of the information supply method according to the first aspect of the invention.

According to still another preferred embodiment, the predetermined information comprises, for each among one or more given locations, an associated function provided to supply, from the received power levels measured on the N channels and after any preprocessing of those measured levels, an estimate of the probability that the measurement was done at the given location, and step b) comprises locating the mobile station based on the probability estimate provided by all or part of the functions from the levels measured in step a) and preprocessed if applicable. In that case, the function(s) can be supplied by the third embodiment of the information supply method according to the first aspect of the invention. In these different embodiments in which the predetermined information comprises one or more functions, it is possible to provide, in step (i), that the levels measured in step a) are preprocessed by applying W different predetermined function(s), W being an integer greater than or equal to 1 and less than N. In particular, it may be provided that the W function(s) are the Q supplied function(s), respectively that the R predetermined function(s) are determined, according to the second embodiment of the information supply method according to the first aspect of the invention.

More generally, it is advantageous for the location method to be implemented to locate the mobile station inside one or more buildings. It is also advantageous for the predetermined information to be established based on received power measurements taken on the N channels at different locations within the given area with the same mobile station that is to be located. Lastly, it is also advantageous—both in the context of the information supply method and in the context of the location method—for N to be greater than or equal to 20, preferably greater than or equal to 50 and more advantageously greater than or equal to 200.

According to a third aspect, the invention proposes software for a mobile station provided to operate in at least one wireless telephony cellular network, said software being provided to have the mobile station carry out the location method according to the invention. According to a fourth aspect, the invention proposes computer software, provided to have the computer implement the following steps:
(a) reception by the computer of a measurement done by a mobile station of the received power level on each channel among the N different predetermined communication channels of at least one wireless telephony cellular network, N being an integer greater than or equal to 7; and
(b) locating the mobile station by carrying out step b) of the location method according to the invention.
   According to a fifth aspect, the invention proposes a mobile station that can operate in a wireless telephony cellular network, which is provided to carry out the location method according to the invention.

### BRIEF DESCRIPTION OF THE DRAWINGS

Other features and advantages of the invention will appear upon reading the following detailed description of embodiments of the invention, provided as an example only and in reference to the appended drawing, comprising:

FIGS. 1 to 3 illustrating a first embodiment;

FIGS. 4 to 6 illustrating a second embodiment; and

FIGS. 7 to 10 illustrating a third embodiment.

### DETAILED DESCRIPTION

The invention proposes a method for locating a mobile station, for example a portable telephone, within a given area—hereafter called location area—covered by at least one wireless telephony cellular network in which the mobile station operates. According to the method, the mobile station measures the received power level on each channel among N different predetermined communication channels of the at least one wireless telephony cellular network, N being an integer greater than or equal to 7. One then locates the mobile station based on the power levels previously measured on the N channels, as well as relevant predetermined information of the correspondence between received power level on each of the N channels and location within the location area.

The mobile station can be not only a mobile telephone, but any other element able to communicate with the wireless telephony cellular network of the cellular type. In particular, the network can be a GSM (Global System for Mobile Communication) network. It can also be a CDMA (Code Division Multiple Access) or WCDMA (Wideband Code Division Multiple Access) network, in particular a UMTS (universal mobile telecommunication system) or CDMA2000 network. The network can also be a PMR (Professional Mobile Radio, also called Private Mobile Radio) network, also called LMR (Land Mobile Radio) network, or a PAMR (Public Access Mobile Radio) network. Using a wireless telephony cellular network is advantageous because the radio waves of the network penetrate inside the buildings, which makes location possible inside buildings.

“Communication channels” refers to the different carriers contained by the frequency band used by the wireless telephony cellular network. The electromagnetic powers of the received channels have the advantage of being easily measured by a mobile station, since it is already provided to perform this type of measurement as a standard feature. Furthermore, the measurements can be done without an obligation to obtain permission from the network owner. Furthermore, any communication channel can be used, regardless of its function in the communication between the mobile station and the base station of the network: voice transmission, data transmission for any type of data such as sound, image, computer data, signaling and network control data, etc.

If within the location area, a same carrier used for reception by the mobile station is shared by several base stations of the network, it is advantageous to extend the measurement not only to the concerned carrier, but also to the base station relative to which the measurement was done. In that case, a channel within the meaning of the invention refers both to the concerned carrier and the base station concerned by the received power measurement done by the mobile station. In other words, a same carrier can in fact be considered to define as many communication channels as there are base stations transmitting on that carrier in the location area.

In the case of a GSM network, the received power levels of the different channels are typically the RSSIs of the concerned carriers of the GSM network for the given BSICs. As a reminder, the RSSI (Received Signal Strength Indicator) is the electric field amplitude value of a carrier and the BSIC (Base Station Identity Code) is the identifier for a base station. In the case of a UMTS (Universal Mobile Telecommunications System) network, the received power levels of the different channels can be the RSCPs (Received Signal Code Power) of a predetermined number of pilot channels (CIPCH, Common Pilot Channel). Hereafter, the described examples will more particularly relate to a GSM network, but they can be adapted to any other type of wireless telephony cellular network, in particular a UMTS or CDMA2000 network.

Using power measurements on at least 7 channels has unexpectedly proven advantageous, as this makes it possible to improve the precision of the location. In fact a technical prejudice prevailed until today, according to which there is a strong redundancy of the information procured by the received powers of the different channels and there is therefore a saturation effect with the number of channels. As a result, in the geolocation applications based on received power measurements, it was considered useless to multiply the measurements over a large number of different channels. But the invention has made it possible to establish that this prejudice was false.

On the contrary, it was unexpectedly observed that the larger the number N of channels on which the measurements are done, the better the precision and reliability of the location. As a result, the number N of channels is chosen to be greater than or equal to 7. More preferably, the number N of channels is chosen to be greater than 10, more advantageously greater than 20, still more advantageously greater than 50 and even more advantageously greater than 200. The number N of channels may even correspond to the total number of channels available on the network. A GSM network can typically comprise more than 500 channels.

In the case where the number N of channels is limited, it is advantageous to perform a prior study of the received power on all of the channels of the network in the location area to select N channels procuring good location discrimination as a function of the power levels measured on those N channels. Although not necessary, this procedure may be used in any situation where the number N of channels is chosen to be less than the total number of channels of the network, but this becomes particularly advantageous when the number N of channels is less than 100 and even more so if it is less than 20. As an example and non-limitingly, one manner of making this selection is to choose the N channels of the network that have, on average, the highest received power in a certain number of locations distributed over the entire location area.

The precision of the location is all the more reliable inasmuch as the received power level measurements on the N channels—used to locate the mobile station—are done by the mobile station substantially in the same place. In practice, the received power level measurements on the N channels are not done simultaneously, but successively over time since the mobile station must tune in each time on the channel to be measured. As a result, the reliability of the location may be decreased if the measurements are done while the mobile station is in motion. But this is not bothersome in most applications, where the mobile station moves slowly or is frequently stopped, or in cases where it is noted that the mobile station has stayed in one place for an abnormally long time. In practice, the measuring time for measuring the received power level on a channel is small, generally much shorter than a second. As a result, the time needed to perform the received power level measurements on the N channels, even if N is high, for example 200 or more, remains limited. As an example, the measurement of the received power level by a standard GSM telephone on about 500 channels is under a minute. Alternatively, it is possible to use a smaller number N of channels, for example less than 20, to reduce the time needed to perform the measurements. This makes it possible to ensure sufficient location reliability, even if the mobile station is in motion during the measurements, inasmuch as the movement speed stays limited. Furthermore, products also exist on the market allowing much faster measurements, for example the product marketed under the name TEMS™ POCKET by the company Ascom Network Testing Inc., Reston, Va., USA for WCDMA and GSM networks. The latter makes it possible to perform the measurements on 500 channels in under a second, which procures a reliable location even when the mobile station is moving at a relatively high speed, for example a pedestrian walking quickly, or even running.

As mentioned above, after measuring the received power level on the N channel stations by the mobile station, the mobile station is located based on the power levels previously measured on the N channels and relevant predetermined information of the correspondence between the received power level on each of the N channels and the location within the location area. Because it is relevant for the correspondence between received power level on each of the N channels and location within the location area, the predetermined information makes it possible to make a deduction regarding the location where the mobile station is located within the location area in light of the power levels measured by it on the N channels.

This predetermined information may be of any nature inasmuch as it makes it possible to perform that deduction. As an example, it involves a database procuring a map of the received power level on the N channels at different given locations within the location area. The deduction is then done based on a comparison of the received power levels measured on the N channels by the mobile station with the power levels of the different locations contained in the database. In other words, it then involves a location technique using pattern matching. The meshing pitch of the locations—which is not necessarily constant—is chosen to provide satisfactory precision for the location, and will in fact depend on the nature of the locations: outside/inside buildings, density of the communication network, etc. It is advantageous for this map to be established by measuring the received power levels in these different locations with the mobile station, which will then be used to perform the geolocation. This makes it possible to ensure that the reliability of the location is not degraded due to the variability of the measurements supplied by different devices.

According to another example, the predetermined information comprises one or more mathematical functions procuring a relationship between the received power levels on the N channels and the corresponding location. Thus, this or these functions supply, from the received power levels on the N channels measured by the mobile station, either the location of the mobile station directly, or one or more data from which the location is deduced. This or these functions can in particular be defined by studying the aforementioned database, in particular through artificial or statistical learning. This solution generally procures a more precise location than the pattern matching techniques.

In the context of the invention, the location can be supplied by the method in the form of a periodic place defined in any coordinate system. The coordinate system can have two dimensions, such as longitude and latitude, or three dimensions, such as longitude, latitude and altitude. Alternatively, the location can be provided in the form of a location consisting of a predetermined geographical volume, for example a room inside a building, or a predetermined geographical area of a surface nature, for example the outside of buildings.

The location method is easy to deploy and quasi-universal, given the fact that it can be implemented in any location area once it is within the coverage of a mobile telephone network and most people today have a mobile telephone or other device communicating with a mobile telephone network. The location method is even more advantageous inasmuch as it also works inside buildings or other locations not covered by GPS signals.

Furthermore, the method does not use information on the architecture of the wireless telephone cellular network, such as the position of the antennas or base stations. In particular, synchronization interaction procedures, frame exchanges with the network, which are generally not freely accessible, are not used. This makes it possible to avoid depending on the operator(s) to implement the method.

The location method can be implemented easily. In fact, it may be implemented on a standard mobile station—for example a mobile telephone—without material modification to the latter. It is necessary only to load it with software to make it carry out the steps of the location method concerning it. Such software can be provided on a computer storage medium, such as a CD-ROM or a hard disk of a server on a computer network—for example Internet—from which it may be downloaded into the mobile station, either directly or indirectly via a computer.

It can be provided that the mobile station carries out the power level measurement step on the N channels of the network and sends, via the wireless communication network for example, to a computer or server, the levels thus measured. The step for locating the mobile station based on these measurements and the predetermined information is then carried out by this computer or server. The predetermined information is in this case stored in the computer or server or any storage means to which it has access. This is advantageous inasmuch as the server generally has more powerful computation means than the mobile station and larger storage means to store the predetermined information. In another embodiment, both the measurement step and the location step of the location method can be implemented by the mobile station itself. In that case, the mobile station can be provided to send, for example via the mobile telephony network, the result of the location to a computer or server or any other device, such as another mobile station operating in the mobile telephony network.

The measurements used to create the predetermined information using a data base containing a map of the received power level on the N channels at different locations within the location area may be done by the mobile station, and preferably by that which is used in the location method. If this database constitutes the predetermined information used in the location method, it is stored in the mobile station in the case where it will be that station that implements the entire location method. The implementation is easy, since one need only load the mobile station with software making it carry out both the method for supplying the predetermined information according to the invention and the location method. On the other hand, if the location step is carried out by a server or a computer, the measurements to form this map are sent to the server, for example via the network. The mobile station can for example send them each time it has measured the N levels on the N channels in a location, or store them to send them all at once after all of the measurements in the different locations have been done.

This may also be the case if the predetermined information used in the location method is obtained by studying the database, in particular through size reduction and/or artificial or statistical learning. In that case, it is in fact preferable for the study to be done using a computer or server that has more powerful computation means. The predetermined information thus obtained can then be sent, via the wireless telecommunications network, to the mobile station if it is that station that implements the entire location method. Alternatively, the predetermined information can be loaded into the mobile station at the same time it is loaded with the software making it carry out the location method.

Whether during the implementation of the location method or to establish the database containing the map of the received power level on the N channels in different given locations within the location area, it is advantageous for the mobile station to perform the received power level measurements on the N channels when it is in standby mode. The fact that the mobile station performs the power measurements on the N channels in standby mode, without it being necessary to establish communication, is advantageous in terms of energy consumption. Since an average user spends 3.3% of his time in telephone communication, the mobile station has all the time necessary to perform the power measurements outside communication time. This also prevents the mobile station from having to perform those measurements while remaining synchronous with the concerned base station for the communication in progress if those measurements were carried out during a communication in progress.

In all cases, the location method is well suited to be implemented in the context of the surveillance of objects or people. This in particular relates to elderly or medicalized persons living alone—for example Alzheimer's patients—, unwatched children, or any person needing very close monitoring of his daily movements for health or safety reasons.

The result of the location can be transmitted by the mobile station or the server, depending on the case, to a third party, for example on a mobile station specific to him, for instance his mobile telephone. The third party can thus be updated at all times on the position of the mobile station. The result of the location can also be sent to a dedicated server. That server can record the successive location information and thus makes it possible to monitor the movement of the monitored person. The server can also emit an alert if necessary.

If the location is done by the mobile station itself, it may be provided for the result of the location to be sent to a third party, who may be a relative, neighbor or security agency. The transmission may be done by SMS or MMS or via ftp on a server that can be viewed online using functionalities of the mobile server. The position updates can take place automatically at predetermined and programmable time intervals. A software application executed on the mobile station can perform such updates. The watcher or third party can thus view, at all times, the movements of the person or object being watched via a remote Internet application.

It may also be provided for the mobile station to send an alert message to the third party when the location has stayed the same for a period of time longer than a particular period. This thereby makes it possible to note an apparent immobility of the monitored person or object for an abnormally long period of time. In the case where the person needs to be rescued, the intervention time can thus be shortened, which improves the person's safety.

Other types of alarms can, however, be considered. For example, an alarm can be triggered manually or upon receipt by the mobile station of a signal coming from an implanted system (defibrillator, pacemaker, motion detector, etc.) sent by Bluetooth® or another low-power/short-range communication protocol. Such alarms can be conveyed to a supervisor or surveillance agency by SMS or telephone call sent from the mobile station of the monitored person or object.

The location method is also applicable in the field of machine-to-machine (M2M) communication. M2M thus makes it possible to manage communications between any device that can be moved with a greater or lesser frequency and the movements of which must be monitored remotely. This may in particular concern machines, vehicles, measurement equipment, medical instruments, or distributors for various products. In such a case, the method is preferably used in a standard M2M GSM or UMTS chip. Other protocols can, however, be considered.

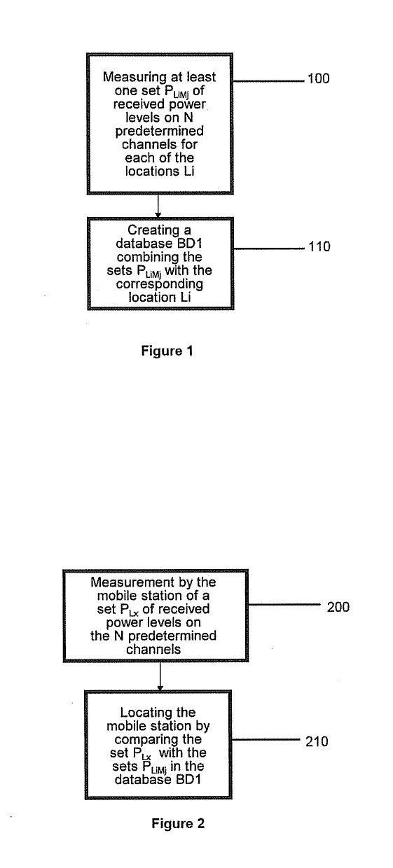

We will now describe, in reference to FIGS. 1 to 3, a first embodiment in which the location method uses a pattern matching technique. FIG. 1 is a flowchart illustrating the method used to provide relevant predetermined information on the correspondence between received power level on each of the N channels and location within the location area, this information then being used by the location method according to this first embodiment. The method comprises a first step 100 for measuring the received power level on each of the N predetermined channels of the network, in each location among a plurality of given locations. These measurements are preferably done with the mobile station subsequently used in the location method.

These locations can each correspond to a periodic place defined in any two- or three-dimensional coordinate system. Alternatively, they can each correspond to a predetermined geographical volume—for example a room inside a building or a given portion within such a room—or a predetermined geographical area of a surface nature, for example the outside of buildings.

The measurement operation on the N channels can be repeated several times within the same location, but at different times to supply several sets of measurements. This makes it possible to reduce the effects of the measurement noise and disruptions that locally and temporarily affect the electromagnetic field. In the case where the given locations correspond to a predetermined volume or a surface area, the measurement operation on the N channels can also be repeated several times at different places within the given location to supply several sets of measurements. This makes it possible to report on the variation of the received power levels on the N channels within the location.

Hereafter, we will designate, by:

Lᵢ: each of the given locations, i being an integer assuming values from 1 to T, T being an integer greater than or equal to 1;

Mj: each series of measurements supplying a set of measurements, j being an integer assuming values from 1 to an integer that is the number of series of measurements done at the considered location Lᵢ;

Cₖ: each of the N communication channels, k being an integer assuming values from 1 to N;

P_{LiMjCk}: the received power level measured on channel Ck during the measurements series Mⱼ at location Lᵢ;

P_{LiMj}: the set made up of the N power levels respectively measured on the N channels during the series of measurements Mⱼ instead of Lᵢ, in other words the set made up of (P_{LiMjC1}, . . . P_{LiMjCk}, . . . P_{LiMjCN}).

Each set P_{LiMj} can be likened to the coordinates of a point or the components of a vector. The method then comprises a second step 110 for creating a database BD1 that associates each of the sets P_{LiMj} with the corresponding location Lᵢ.

In the database BD1, the locations Lᵢ are referenced using any identification system whatsoever. This may involve the coordinates of the locations Lᵢ in the event the locations Li correspond to a periodic place. In the event the locations Lᵢ correspond to a predetermined volume or a surface area, they may for example be referenced using an order number, a code or the name of the concerned room or area.

The database BD1 therefore assumes the form of a table of the following type:

| | | | | | |
|---|---|---|---|---|---|
| L₁ | P_{L1M1C1} | . . . | P_{L1M1Ck} | . . . | P_{L1M1CN} |
| L₁ | P_{L1M2C1} | . . . | P_{L1M2Ck} | . . . | P_{L1M2CN} |
| . . . | . . . | . . . | . . . | . . . | . . . |
| Lᵢ | P_{LiM1C1} | . . . | P_{LiM1Ck} | . . . | P_{LiM1CN} |
| . . . | . . . | . . . | . . . | . . . | . . . |
| L_{T} | P_{LTM4C1} | . . . | P_{LTM4Ck} | . . . | P_{LTM4CN} |

It will be understood that steps 100 and 110 are not necessarily consecutive, but can instead be concomitant. During step 100, it can be provided for the user to enter the reference of the concerned location Lᵢ in the mobile station that is used in step 110 to create the database. This has the advantage of being easy to implement.

The creation of the database can thus assume the form of a set, during which the mobile station, once a set P_{LiMj} is acquired, uses a voice synthesizer to ask the user for his current position, for example the name or number of the room in the building. The user then supplies this on the keypad of the mobile station, or by voice recognition. Voice synthesis and recognition systems are already common on mobile telephones.

FIG. 2 is a flowchart illustrating the location method in the context of this first embodiment. The location method comprises a first step 200 for measuring, by the mobile station, the received power level on each of the channels Ck. These measurements are done at the time one wishes to locate the mobile station, i.e. to determine the location in which it is located, which is denoted Lₓ hereafter. N received power levels are thus supplied, each corresponding to a respective channel Cₖ, and which are subsequently denoted P_{LxC1}, . . . P_{LxCk}, . . . P_{LxCN}.

These N received power levels define a set denoted P_{Lx}. This set P_{Lx} can be considered to define the coordinates of a point in the same coordinate system or the components of a vector in the same base as the sets P_{LiMj}. The location method then comprises a second step 210 for comparing the set P_{Lx} with the sets P_{LiMj} in the database BD1. The location Lₓ is identified based on that comparison.

The comparison can be done based on the distance separating the point defined by P_{Lx} from each of the points P_{LiMj} that is determined through computation. The distance is preferably the Euclidian distance, which is therefore calculated using the following formula:

$$d = \sqrt{{\sum }_{k = 1}^{N} {( {P}_{LxCk} - {P}_{LiMjCk} )}^{2}}$$

Nevertheless, any other type of distance can be used, such as a distance L₁ or a distance L_{∞}. The location Lx can be identified as the location Lᵢ that corresponds to the point P_{LiMj} that has the smallest distance with point P_{Lx}.

It can be considered not to perform the comparison for all of the sets P_{LiMj} of the database BD1. For example, the comparisons may be stopped once a set P_{LiMj} has supplied a distance below a predetermined threshold, in which case the location Lx is considered to correspond to the location Li of that set P_{LiMj}.

Alternatively, it may be provided to locate the location Lₓ at the barycenter of a subset of several locations Lᵢ. The locations Lᵢ of that subset may be those that have a distance below a predetermined threshold. Alternatively, the subset of locations Lᵢ may be determined by a number B of locations Lᵢ that have the smallest distances. The number B can be predetermined or depend on the distances computed for the different P_{LiMj}.

In the calculation of the barycenter, each location Lᵢ used is affected by the same weight. Alternatively, each location Lᵢ used is weighted according to the distance(s) of the different P_{LiMj} of that location Li. This may in particular involve weighting in 1/d. Using a barycenter calculation makes it possible to improve the location precision. This solution is preferably applied in the case where the locations correspond to periodic places referenced in database BD1 by coordinates.

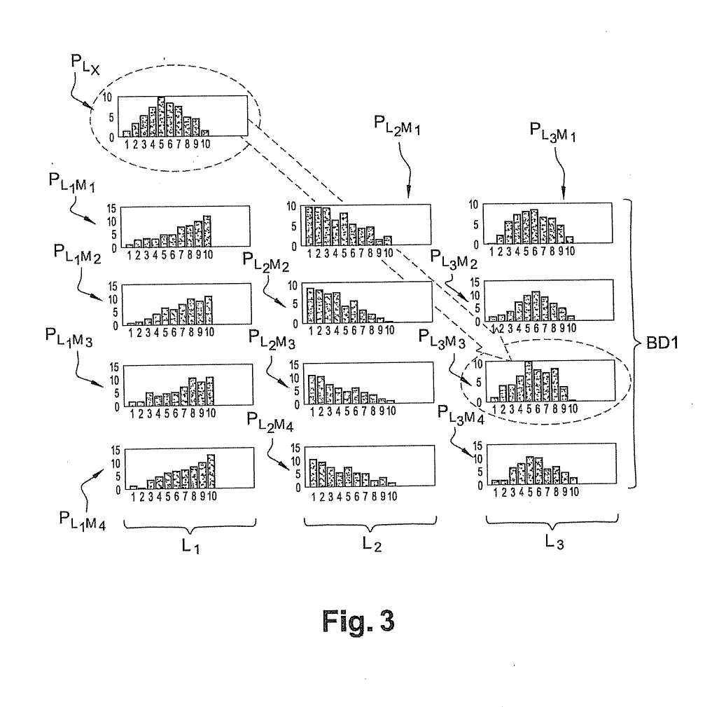

FIG. 3 illustrates an example of application of the first embodiment. For simplification reasons, the location area in this example is limited to 3 locations, respectively referenced L₁, L₂ and L₃. In other words, ‘i’ assumes values 1, 2 and 3. The number N of channels is 10 in this case.

The method is first implemented for supplying the predetermined information in the form of database BD1 as described relative to FIG. 1. In each location L₁, L₂ and L₃, four distinct series of measurements are carried out of the received power level on the ten channels considered according to step 100 of the method: cf. FIG. 1. The measurement series for each location Lᵢ are referenced M₁, M₂, M₃ and M₄, in other words ‘j’ assumes values 1, 2, 3 and 4. The database BD1 is created according to step 110 of the method by associating each set P_{LiMj} with the corresponding location Lᵢ.

The power levels P_{LiMjCk} are shown in FIG. 3 by the vertical bars inside the corresponding boxes. The location method is then implemented using the database BD1 thus formed, in the manner described relative to FIG. 2. More particularly, when one wishes to locate the mobile station, the latter performs the received power measurements on the 10 channels to supply the set P_{Lx} according to step 200. Lₓ is then determined by comparing that set P_{Lx} to the sets P_{LiMj} in the database BD1 according to step 210 of the method. In the case at hand, the location Lx is considered to be location L₃ because the set P_{L3M3} is that of the group of sets P_{LiMj} that has the smallest Euclidian distance with set P_{Lx}.

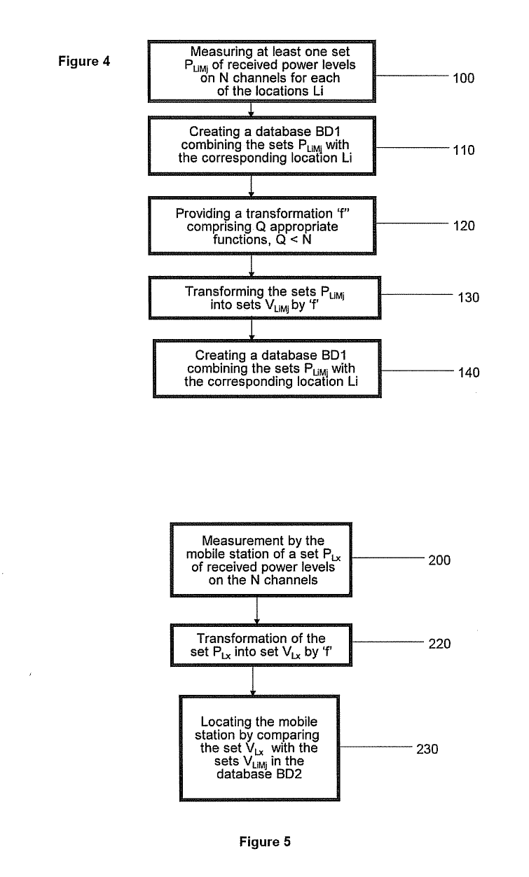

In reference to FIGS. 4 to 6, we will now describe a second embodiment based on the first embodiment, but which also uses preprocessing of the data. FIG. 4 is a flowchart illustrating the method used to supply the relevant predetermined information of the correspondence between received power level on each of the N channels and location within the location area, this information then being used by the location method according to the first embodiment. As visible in the flowchart, the method comprises the same steps 100 and 110 as the method according to the first embodiment described in reference to FIG. 1. The entire description of these two steps in the context of the first embodiment is identically applicable to this second embodiment and will therefore not be repeated here.

The method according to this second embodiment does, however, comprise additional steps 120, 130 and 140. The purpose of these additional steps is to supply a second database BD2 from preprocessing of the first database BD1 obtained in step 110. The function of this preprocessing is to supply a second database BD2 that is smaller in size than the first database BD1. Thus, step 120 consists of supplying Q functions—each denoted ‘fₚ’—which together define a transformation denoted ‘f’, Q being an integer greater than or equal to 1 and less than N, and p an integer assuming values from 1 to Q.

In step 130, this ‘f’ transformation is applied to each set P_{LiMj} of the first database BD1 to supply a new corresponding set of values V_{LiMj}. In other words, each function ‘fₚ’ is applied to the set P_{LiMj} to supply a respective value—denoted V_{LiMj,p}—of the set of value(s) V_{LiMj}, which can be summarized as follows:

$$\begin{matrix}{V}_{LiMj} = f ( {P}_{LiMj} ) \\ = [ {f}_{1} ( {P}_{LiMj} ) , … , {f}_{p} ( {P}_{LiMj} ) , … , {f}_{Q} ( {P}_{LiMj} ) ] \\ = [ {V}_{LiMj , 1} , … , {V}_{LiMj , p} , … , {V}_{LiMj , Q} ]\end{matrix}$$

The method then comprises a step 140 for creating a second database BD2 that associates each of the sets V_{LiMj} with the corresponding location Lᵢ. It will be understood that steps 120 to 140 of the method are not necessarily consecutive, but can instead overlap. In the second database BD2, the locations Lᵢ are preferably referenced in the same manner as in the first database BD1.

The database BD2 therefore assumes the form of a table of the following type:

| | | | | | |
|---|---|---|---|---|---|
| L₁ | V_{L1M1,1} | . . . | V_{L1M1,p} | . . . | V_{L1M1,Q} |
| L₁ | V_{L1M2,1} | . . . | V_{L1M2,p} | . . . | V_{L1M2,Q} |
| . . . | . . . | . . . | . . . | . . . | . . . |
| Lᵢ | V_{LiM1,1} | . . . | V_{LiM1,p} | . . . | V_{LiM1,Q} |
| . . . | . . . | . . . | . . . | . . . | . . . |
| L_{T} | V_{LTM4,1} | . . . | V_{LTM4,p} | . . . | V_{LTM4,Q} |

Similarly to the sets P_{LiMj}, each set V_{LiMj} can also be likened to the coordinates of a point or the components of a vector.

The ‘f’ transformation is preferably chosen so that the set(s) of value(s) V_{LiMj} associated with the locations Lᵢ is (are) discriminating for the corresponding location Li relative to the sets of value(s) obtained by ‘f’ that are associated with the other locations. In other words, the functions ‘fₚ’ are chosen so that, for any pair of different sets P_{LiMj} of the database BD1, the transformation of each of those two sets P_{LiMj} by ‘f’ gives two sets V_{LiMj} that are different from one another, and that are preferably as different as possible to provide the best possible discrimination.

To that end, to define the functions ‘fₚ’, any statistical method known in itself can be used, applied to the database BD1. This may for example be a primary component analysis (PCA) or an independent component analysis. In both of these cases, the first components, which are discriminating for the entire set of values P_{LiMj}, can be used.

The ‘f’ transformation can be a linear combination of the measured received power levels P_{LiMjCk}, as is the case for a primary component analysis, or a nonlinear combination, as may be the case for an independent component analysis. Another possibility consists of defining each function ‘fₚ’ as supplying a given moment of the distribution of the levels P_{LiMjCk} constituting a set P_{LiMj}, such as the average, standard deviation, and possibly other, high-order moments. In this case one can use the lowest-order moments that are discriminating for all of the sets of values P_{LiMj}. The preprocessing transformation can also be a function made up of several transformations obtained using the aforementioned techniques.

FIG. 5 is a flowchart illustrating the location method in the context of this second embodiment. The first step 200 of the method is identical to that of the first embodiment. It involves measuring, via the mobile station, the received power level on each of the channels Ck to supply a set P_{Lx} of N power levels P_{LxC1}, . . . P_{LxCk}, . . . P_{LxCN} as described for the first embodiment.

Unlike the first embodiment, the set P_{Lx} is preprocessed—in step 220—to make it homogenous with the sets V_{LiMj} in the second database BD2. To that end, the ‘f’ transformation is applied to the set P_{Lx} to provide a set of value(s) denoted V_{Lx}. In other words, each function ‘fₚ’ is applied to the set P_{Lx} to supply a respective value—denoted V_{Lx,p}—of the set of value(s) V_{Lx}, which can be summarized as follows:

$$\begin{matrix}{V}_{Lx} = f ( {P}_{Lx} ) \\ = [ {f}_{1} ( {P}_{Lx} ) , … , {f}_{p } ( {P}_{Lx} ) , … , {f}_{Q} ( {P}_{Lx} ) ] \\ = [ {V}_{Lx , 1} , … , {V}_{Lx , p} , … , {V}_{Lx , Q} ]\end{matrix}$$

This set V_{Lx} can also be considered to define the coordinates of a point in the same coordinate system or the components of a vector in the same database as the sets V_{LiMj}.

The location method then comprises a step 230 for comparing the set V_{Lx} with the sets V_{LiMj}, in the second database BD2 to identify the location Lx. This comparison step is carried out similarly to step 210 in the context of the first embodiment, except that it is done based on the set V_{Lx} and sets V_{LiMj}. Thus, the identification can be done by determining a minimum distance or by calculating a barycenter. The entire description provided concerning step 210 of the first embodiment applies mutatis mutandis to said step 230 of the second embodiment and will therefore not be repeated here.

In the location method according to the second embodiment, the first database is not used, but only the second database BD2. Using preprocessing to supply a second database BD2 with a smaller size than the first database BD1 is advantageous due both to the savings in terms of storage spaces and simplification of the comparison operations in step 230. This is in particular the case if the location method is implemented by the mobile station itself.

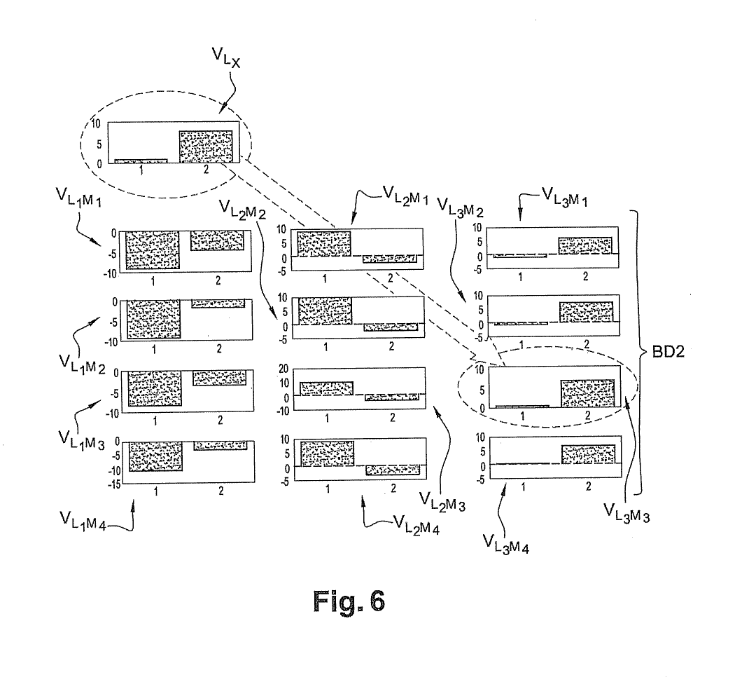

FIG. 6 illustrates an example of application of the second embodiment. It is based on the example described in reference to FIG. 3. The creation of the database BD1 is for example done by applying steps 100 and 110 of the method, as described for FIG. 3 in the context of the first embodiment. The first database BD1 was not shown in FIG. 6, since it is the one shown in FIG. 3.

In this example, in step 120 an ‘f’ transformation was chosen obtained by primary component analysis of database BD1. In that case, the functions ‘f₁’ and ‘f₂’ were used corresponding to the first two primary components because they supply the desired discrimination between the different sets of values V_{LiMj}. Q is therefore equal to 2 and ‘p’ assumes values 1 and 2.

According to steps 130 and 140, the sets V_{LiMj} are calculated and associated with the corresponding locations Lᵢ within a second database BD2, with ‘i’ assuming values 1, 2 and 3 and ‘j’ assuming values 1, 2, 3 and 4. The sets V_{LiMj} are the transforms of each set P_{LiMj} by the functions ‘f₁’ and ‘f₂’ and therefore each comprise two values V_{LiMj,1} and V_{LiMj,2}. In other words,

$$\begin{matrix}{V}_{LiMj} = f ( {P}_{LiMj} ) \\ = [ {f}_{1} ( {P}_{LiMj} ) , {f}_{2} ( {P}_{LiMj} ) ] \\ = [ {V}_{LiMj , 1} , {V}_{LiMj , 2} ]\end{matrix}$$

The values V_{LiMj,1} and V_{LiMj,2} of each set V_{LiMj} are shown in FIG. 6 by the vertical bars inside the corresponding boxes. The location method is then implemented using the second database BD2 thus formed, in the manner described relative to FIG. 5.

More particularly, when one wishes to locate the mobile station, the latter performs the received power measurements on the 10 channels to supply the set P_{Lx} according to step 200. The set V_{Lx} is then calculated, which is the transform of P_{Lx} by ‘f’. In other words,

$$\begin{matrix}{V}_{Lx} = f ( {P}_{Lx} ) \\ = [ {f}_{1} ( {P}_{Lx} ) , {f}_{2} ( {P}_{Lx} ) ] \\ = [ {V}_{Lx , 1} , {V}_{Lx , 2} ]\end{matrix}$$

The values V_{Lx,1} and V_{Lx,2} of the set V_{Lx} are shown in FIG. 6. The location Lₓ is then determined by comparing the set V_{Lx} to the sets V_{LiMj} in the second database BD2 according to step 230 of the method. In this case, the location Lx is again considered to be the location L₃ because the set V_{L3M3} is that of the group of sets V_{LiMj} that has the smallest Euclidian distance with the set V_{Lx}.

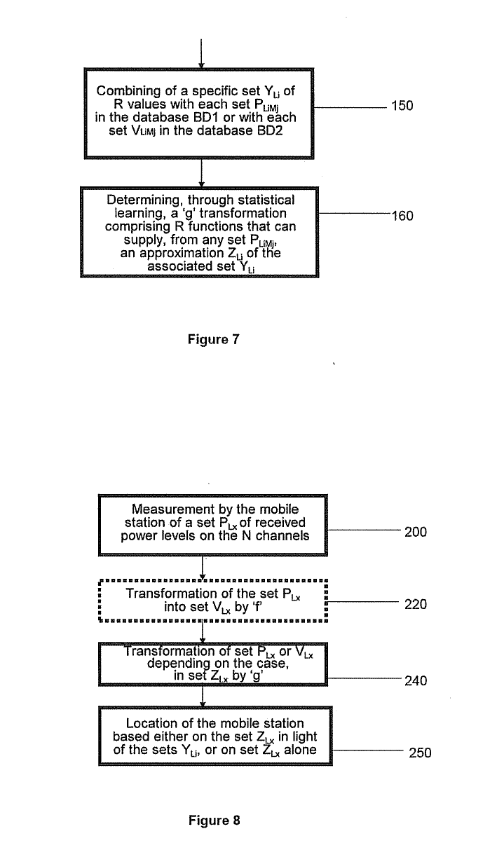

In reference to FIGS. 7 to 10, we will now describe a third embodiment that uses statistical or artificial learning. This third embodiment is preferred inasmuch as it procures better location precision than the first and second embodiments. FIG. 7 is a flowchart illustrating the method used to supply the relevant predetermined information of the correspondence between received power level on each of the N channels and location within the location area, this information then being used by the location method according to this third embodiment.

The method according to this third embodiment comprises steps 150 and 160 that are applied in combination with those either of the method described in reference to FIG. 1 of the first embodiment, or the method described in reference to FIG. 4 of the second embodiment. Regarding its application in combination with the method described in reference to FIG. 1 of the first embodiment, this means that the method comprises the same steps 100 and 110 as the method according to the first embodiment described in reference to FIG. 1. The entire description of these two steps in the context of the first embodiment is identically applicable to this second embodiment and therefore will not be repeated here.

Step 150 consists of defining, for each location Lᵢ, a set of R predetermined value(s) that is specific to that location, R being an integer set to be identical for all of the locations Lᵢ and greater than or equal to 1. This set of values will be denoted Y_{Li} hereafter. Each of the values making up the set Y_{Li} will be denoted Y_{Li,a}, with ‘a’ an integer assuming values from 1 to R. Here again, each set Y_{Li} can be likened to the coordinates of a point or a vector.

Preferably, these sets Y_{Li} serve to identify the different locations Lᵢ in the database BD1. In other words, the sets P_{LiMj} are each associated with the corresponding set Y_{Li} in the database BD1. Step 150 is therefore not necessarily consecutive to steps 100 and 110, but can overlap the latter.

The database BD1 therefore assumes the form of a table of the following type:

| | | | | | | | |
|---|---|---|---|---|---|---|---|
| Y_{L1,1} | . . . | Y_{L1,R} | P_{L1M1C1} | . . . | P_{L1M1Ck} | . . . | P_{L1M1CN} |
| Y_{L1,1} | . . . | Y_{L1,R} | P_{L1M2C1} | . . . | P_{L1M2Ck} | . . . | P_{L1M2CN} |
| . . . | . . . | . . . | . . . | . . . | . . . | . . . | . . . |
| Y_{Li,1} | . . . | Y_{Li,R} | P_{LiM1C1} | . . . | P_{LiM1Ck} | . . . | P_{LiM1CN} |
| . . . | . . . | . . . | . . . | . . . | . . . | . . . | . . . |
| Y_{LT,1} | . . . | Y_{Li,R} | P_{LTM4C1} | . . . | P_{LTM4Ck} | . . . | P_{LTM4CN} |

As an example, the Y_{Li} sets comprise only a single value—i.e. R is equal to 1—which corresponds to a number assigned to the location Lᵢ, for example the number of the corresponding room in a building. According to another example, the sets Y_{Li} can comprise two values, three values, respectively—i.e. R is equal to 2, to 3, respectively—which correspond to the coordinates of the location Li in a system of two-dimensional coordinates, three-dimensional coordinates, respectively. These examples are of course not limiting.

Step 160 consists of determining, through statistical or artificial learning from the database BD1, a set of R function(s)—each denoted ‘gₐ’—able to provide, from each set P_{LiMj}, a set—denoted Z_{LiMj}—of R value(s) that is an approximation of the set Y_{Li} associated with the set P_{LiMj} in the database BD1. This set of R function(s) ‘gₐ’ defines a transform hereafter denoted ‘g’. In this third embodiment, this ‘g’ transform constitutes the relevant predetermined information of the correspondence between received power level on each of the N channels and location within the location area, which will then be used in the context of the location method.

Regarding the application of steps 150 and 160 in combination with the method described in reference to FIG. 4 of the second embodiment, this means that the method comprises the same steps 100 to 140 as the method according to the second embodiment described in reference to FIG. 4. As a result, the entire description of said steps 100 to 140 in the context of the second embodiment is identically applicable to this third embodiment and will therefore not be repeated here.

Step 150 is identical to the preceding alternative embodiment in combination with the method described in reference to FIG. 1 of the first embodiment. As a result, the description provided in step 150 for the preceding alternative is also applicable here, with the exception that preferably, the sets Y_{Li} serve as identification for the different locations Lᵢ in the second database BD2. In other words, the sets V_{LiMj} are each associated with the corresponding set Y_{Li} in the second database BD2. Consequently, step 150 is also not necessarily consecutive to steps 100 to 140, but can overlap the latter.

The second database BD2 therefore assumes the form of a table of the following type:

| | | | | | | | |
|---|---|---|---|---|---|---|---|
| Y_{L1,1} | . . . | Y_{L1,R} | V_{L1M1,1} | . . . | V_{L1M1,p} | . . . | V_{L1M1,Q} |
| Y_{L1,1} | . . . | Y_{L1,R} | V_{L1M2,1} | . . . | V_{L1M2,p} | . . . | V_{L1M2,Q} |
| . . . | . . . | . . . | . . . | . . . | . . . | . . . | . . . |
| Y_{Li,1} | . . . | Y_{Li,R} | V_{LiM1,1} | . . . | V_{LiM1,p} | . . . | V_{LiM1,Q} |
| . . . | . . . | . . . | . . . | . . . | . . . | . . . | . . . |
| Y_{LT,1} | . . . | Y_{LT,R} | V_{LTM4,1} | . . . | V_{LTM4,p} | . . . | V_{LTM4,Q} |

In this alternative, step 160 consists of determining, through statistical or artificial learning from the second database BD2 (instead of the first database BD1), a set of R function(s)—also each denoted ‘gₐ’—able to provide, from each set V_{LiMj} (instead of P_{LiMj}), a set—denoted Z_{LiMj}—of R value(s) that is an approximation of the set Y_{Li} associated with the set V_{LiMj} in the second database BD2 (instead of the first database BD1). As in the previous alternative, this set of R function(s) ‘gₐ’ defines a transformation hereafter denoted ‘g’ and constitutes the relevant predetermined information for the correspondence between each received power level on each of the N channels and location within the location area, which will then be used in the context of the location method.

Generally, the artificial or statistical learning is known in itself. It consists of establishing a provisional model whereof the parameters are determined from the data themselves, rather than a priori knowledge or hypotheses. The traditional steps of the analysis by learning of a system comprise, non-limitingly:
establishing learning and validation bases that ensure the best possible representativeness of those bases;
optionally, extracting optimal characteristic features from the raw data, in particular but not exclusively through primary component analysis or independent component analysis as described in the context of the second embodiment;
selecting the most significant characteristic features, in particular but not exclusively using the probe variable method;
building classification or regression architectures supplied by these features, in particular using the so-called K closest neighbors method, using a network of neurons, or core classifiers such as support vector machines SVM or TSVM;
choosing the best model via cross-validation techniques.
   Artificial or statistical learning is more fully described for example in Neural Networks: Methodology and Applications by Gerard Dreyfus, Springer, 2004, which is incorporated by reference into this description.

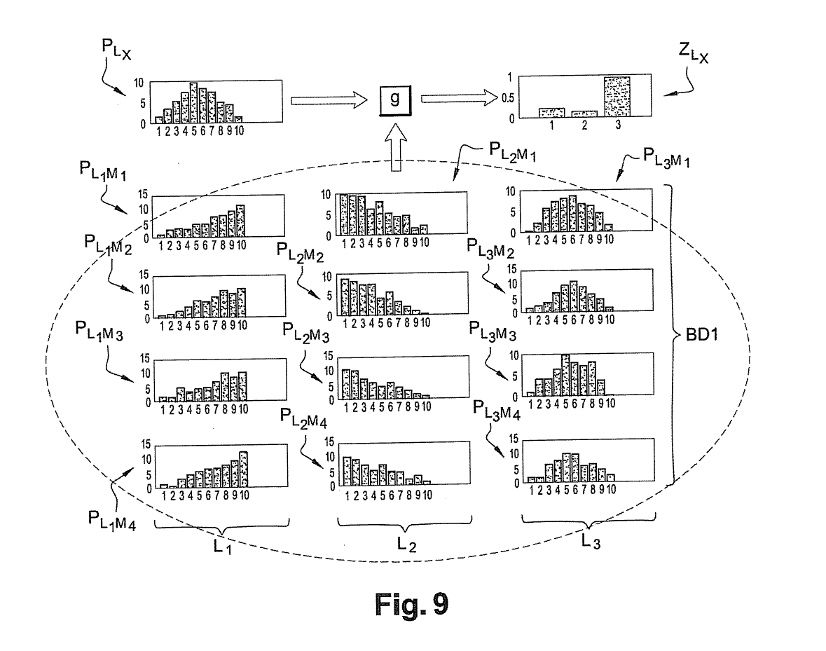

In this third embodiment, the location method is implemented using the ‘g’ transformation previously obtained, in the manner described relative to FIG. 8. The first step 200 of the method is identical to that of the first embodiment. It involves the measurement, by the mobile station, of the received power level on each of the channels Ck to supply a set P_{Lx} of N power levels P_{LxC1}, . . . P_{LxCk}, . . . P_{LxCN} as described for the first embodiment.

If, to establish the ‘g’ transformation, one has opted for the alternative of the third embodiment consisting of applying steps 150 and 160 combined with the method described in reference to FIG. 4 of the second embodiment, then the preprocessing step 220 is applied, i.e. the application to the set P_{Lx} of the ‘f’ transformation to supply the set V_{Lx}. This step 220 is that already described in the context of the second embodiment.

In step 240, the ‘g’ transformation is applied to the set V_{Lx} to obtain a set Z_{Lx}.

In other words:

$$\begin{matrix}{Z}_{Lx} = g ( {V}_{Lx} ) \\ = [ {g}_{1} ( {V}_{Lx} ) , … , {g}_{a} ( {V}_{Lx} ) , … , {g}_{R} ( {V}_{Lx} ) ]\end{matrix}$$

If, to establish the ‘g’ transformation, one has opted for the alternative consisting of applying steps 150 and 160 in combination with the method described in reference to FIG. 1 of the first embodiment, then the preprocessing step 220 is omitted. In that case, in step 240, the ‘g’ transformation is applied to the set P_{Lx} to obtain the set Z_{Lx}.

In other words:

$$\begin{matrix}{Z}_{Lx} = g ( {P}_{Lx} ) \\ = [ {g}_{1} ( {P}_{Lx} ) , … , {g}_{a } ( {P}_{Lx} ) , … , {g}_{R} ( {P}_{Lx} ) ]\end{matrix}$$

In both alternatives, the method then comprises a step 250 for locating the mobile station based on the set Z_{Lx}. It is possible to perform this location by comparing the set Z_{Lx} with the sets Y_{Li} (alternatively, with the sets Z_{Li}) to identify the location Lx. This comparison step can consist of looking for the set Y_{Li}(respectively Z_{Li}) that has the smallest minimum distance with Z_{Lx}. This comparison can then be carried out in a manner similar to that described for step 210 in the context of the first embodiment, except that it is done based on the set Z_{Lx} and the sets Y_{Li} instead of the set P_{LX} and the sets P_{LiMj}.

But according to one advantageous embodiment, the location is procured based on set Z_{Lx} alone, i.e. without using a comparison with the sets Y_{Li}, or with the sets Z_{Li}. There is therefore no need to have the sets Y_{Li} or Z_{Li} available to implement the location method. For example, this is the case when the values making up the sets Y_{Li} are the coordinates of the location Lᵢ in any coordinate system whatsoever. In that case, the set Z_{Lx} supplies an approximation of the location Lx in that same coordinate system. As a result, the set Z_{Lx} is then considered to be the location of Lₓ that is given in that coordinate system.

Alternatively, in the case where the given locations Lᵢ each correspond to a predetermined volume or surface area, the referencing system of the locations Lᵢ by the sets Y_{Li} can be chosen so that the location Lₓ can be identified based on the set Z_{Li} without comparison operation with the sets Y_{Li}. For example, if each value making up the sets Y_{Li} is chosen in the form of an integer, it then suffices to round each value of the set Z_{Lx} to the closest integer to obtain the location Lᵢ to be located. This method is particularly reliable in the case where the sets Y_{Li} include only a single value, i.e. the case where R is equal to 1.

FIG. 9 illustrates an example of application of the third embodiment, in the application alternative combined with the first embodiment. It is based on the example described in reference to FIG. 3. The creation of the database BD1 is done by applying steps 100 and 110 of the method, as described for FIG. 3 in the context of the first embodiment. The database BD1 is shown again in FIG. 9.

In applying step 150, the following sets Y_{Li} have been defined:
for L₁, the set Y_{L1} defined by (1,0,0);
for L₂, the set Y_{L2} defined by (0,1,0);
for L₃, the set Y_{L3} defined by (0,0,1).
   In other words, R is equal to 3 in this example. The ‘g’ transformation is obtained through statistical or artificial learning from the database BD1 by applying step 160.

In our example, the ‘g’ transformation can be sought in the form of three functions g₁, g₂ and g₃ that respectively provide an estimate of the location probability of the mobile station in locations L₁, L₂ and L₃, this probability being expressed between 0 and 1. In that case, Z_{Lx} can be expressed in the form:

Z_{Lx,1}=g₁(P_{Lx})=σ(Σb_{1,k}·P_{LxCk})

Z_{Lx,2}=g₂(P_{Lx})=σ(Σb_{2,k}·P_{LxCk})

Z_{Lx,3}=g₃(P_{Lx})=Σ(σb_{3,k}·P_{LxCk})

with:
Z_{Lx,1}, Z_{Lx,2} and Z_{Lx,3}: the values making up the set Z_{Lx};
b_{1,k}, b_{2,k} and b_{3,k}: coefficients determined by statistical learning from the first database BD1, which are the multiplicative coefficients of the power levels P_{LxCk} measured on the different channels Ck instead of Lx, the summation being done for the whole index k assuming values from 1 to N;
σ(x)=1/(1+e^{-X}); and
gᵢ(P_{Lx}): an estimate of the probability that the measurement P_{Lx} was done at location Lᵢ.

The location method is then implemented using the ‘g’ transformation thus obtained, in the manner described relative to FIG. 8. More particularly, when one wishes to locate the mobile station, the latter performs the received power measurements on the 10 channels to supply the set P_{Lx} according to step 200. In applying step 240, the set Z_{Lx} is then computed that is the transform of P_{Lx} by ‘g’. The values making up the set Z_{Lx} are shown by vertical bars in FIG. 9.

In applying step 250, the location Lx is determined by comparing the set Z_{Lx} to the sets Y_{Li}. In this case, it is the set Y_{L3} that has the smallest distance—for example the Euclidian distance—with the set Z_{Lx}. Consequently, the mobile station is considered to be located at location L₃.

In the context of this example, the determination of the location Lₓ can be done other than by using the comparison step 250. In the case at hand, the determination of the location Lₓ can be done by rounding each of the values Z_{Lx,1}, Z_{Lx,2} and Z_{LX,3} making up the set Z_{Lx} to the closest integer. The group thus obtained is the set Y_{Li} that corresponds to the location Lx. In this case, it emerges from the graphic illustration of the values making up Z_{Lx} in FIG. 9 that one obtains the group (0, 0, 1), i.e. the set Y_{L3}. According to another advantageous possibility, the location Lx can be determined by considering that it corresponds to the location Lᵢ for which the corresponding function gᵢ—applied to the set P_{Lx}—has supplied the highest probability, in other words L₃ in our example as shown in FIG. 9. Of course, this example of FIG. 9 can be generalized to any number of locations Li, i.e. for any integer T.

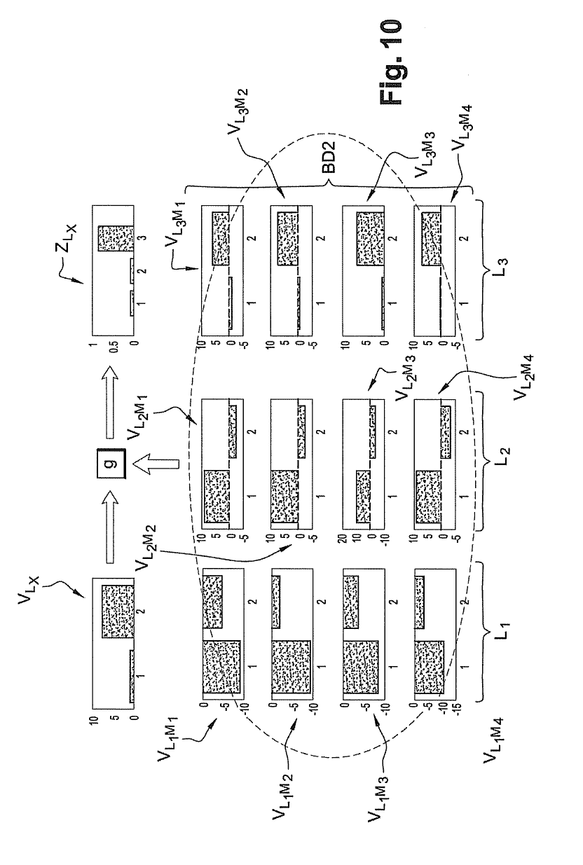

FIG. 10 illustrates an example of application of the third embodiment, in its alternative application combined with the second embodiment. It is based on the example described in reference to FIG. 6. The creation of the first database BD1, then the second database BD2 is done as described for FIG. 6 of the second embodiment. Only the second database BD2 is shown in FIG. 10.

In applying step 150, the same sets Y_{Li} were defined as in the context of the example of FIG. 9, i.e.:
for L₁, the set Y_{L1} defined by (1,0,0);
for L₂, the set Y_{L2} defined by (0,1,0);
for L₃, the set Y_{L3} defined by (0,0,1).
   In applying step 160, the ‘g’ transformation is obtained this time by statistical or artificial learning from the second database BD2.

Here again, the ‘g’ transformation can be sought in the form of three functions g₁, g₂ and g₃ that respectively supply an estimate of the probability of locating the mobile station at locations L₁, L₂ and L₃, this probability being expressed between 0 and 1. In this case, Z_{Lx} can be expressed in the form:

Z_{Lx,1}=gᵢ(V_{Lx})=σ(Σb_{1,p}·V_{Lx,p})

Z_{Lx,2}=g₂(V_{Lx})=σ(Σb_{2,p}·V_{Lx,p})

Z_{Lx,3}=g₃(V_{Lx})=σ(Σb_{3,p}·V_{Lx,p})

with:
Z_{Lx,1}, Z_{Lx,2} and Z_{Lx,3}: the values making up the set Z_{Lx};
b_{1,p}, b_{2,p}, b_{3,p}: coefficients determined by statistical learning from the second database BD2, which are the multiplicative coefficients of the values V_{Lx,p}, the summation being done for the whole p index assuming values from 1 to Q; and
σ(x)=1/(1+e^{-X}); and
gᵢ(V_{Lx}): an estimate of the probability that the measurement P_{Lx} was done at location Lᵢ.

The location method is then implemented using the ‘g’ transformation thus obtained, in the manner described relative to FIG. 8. More particularly, when one wishes to locate the mobile station, the latter performs the received power measurements on the 10 channels to supply the set P_{Lx} according to step 200, then, in applying step 220, the set V_{Lx} is computed by applying the ‘f’ transformation. In applying step 240, the set Z_{Lx} is then computed, which is the transform of V_{Lx} by ‘g’. The values making up the set Z_{Lx} are represented by vertical bars in FIG. 10.

In applying step 250, the location Lx is determined by comparing the set Z_{Lx} to the sets Y_{Li} in a manner similar to the case of FIG. 9. In this case, it is also set Y_{L3} that has the smallest distance with set Z_{Lx}. As a result, the mobile station is considered to be located at location L₃. As in the previous case, the determination of the location Lₓ can be done by rounding each of the values making up the set Z_{Lx} to the closest integer, which provides the set Y_{Li} corresponding to the location Lx. Or also alternatively, the location Lₓ can also be considered to be the location Lᵢ for which the corresponding function gᵢ—applied to the set P_{Lx}—has supplied the highest probability, in other words L₃ in our example, as shown in FIG. 10. Of course, this example can also be generalized to any number of locations Li, i.e. for any integer T.

Of course, the present invention is not limited to the examples and embodiment described and shown, but is open to many alternatives accessible to those skilled in the art.

1. A method for supplying information that can be used to locate a mobile station within a given area covered by at least one wireless telephony cellular network in which the mobile station operates, the method comprising:
for one or more given locations within the given area, providing, for each of the given locations, at least one set of N values, each of the values corresponding to a measured reception power level on a respective channel among N different predetermined communication channels of the at least one wireless telephony cellular network, N being a fixed integer greater than or equal to 7; and
creating a first database associating each set of N values with the corresponding given measurement location.

2. The method according to claim 1, comprising:
for each one among one or more given locations within the given area, defining a set of R predetermined value(s) that is specific to that given location, R being an integer greater than or equal to 1, this set of R predetermined value(s) being associated with each set of N values provided for the corresponding given location in the first database; and
determining, by statistical learning from the first database, a set of R function(s) that can provide, from each set of N values, a set of R values that is an approximation of the set of R predetermined value(s) associated with said set of N values.

3. The method according to claim 1, comprising:
providing Q different function(s), Q being an integer greater than or equal to 1 and less than N; and
creating a second database from the first database by applying, to each set of N values, the Q function(s) to provide a corresponding set of Q value(s), the set of Q value(s) being associated in the second database with the corresponding given measurement location,
wherein the Q function(s) are chosen so that, for any pair of sets of N different values of the database, the two sets of Q values obtained by applying those Q functions to that pair of sets of N values are different from one another.

4. The method according to claim 3, wherein:
the Q function(s) are provided either through an analysis of primary components, or through an analysis of independent components; or
the Q function(s) respectively provide the average value, standard deviation, and other higher-order moments of the set of N values.

5. The method according to claim 3, comprising:
for each one among one or more given locations within the given area, the definition of a set of R predetermined value(s) that is specific to that given location, R being an integer greater than or equal to 1, this set of R predetermined value(s) being associated with each set of Q values provided for the corresponding given location in the second database; and
determining, by statistical learning from the second database, a set of R function(s) that can provide, from each set of Q value(s), a set of R value(s) that is an approximation of the set of R predetermined value(s) associated with said set of Q value(s).

6. The method according to claim 1, comprising:
for each given location, the determination, by statistical learning from either the first database or the second database, of a function able to provide, respectively from the set of N values or the set of Q value(s) obtained by applying the Q function(s) to the set of N values, an estimate of the probability that the measurement was done in that given location.

7. A method for locating a mobile station within a given area covered by at least one wireless telephony cellular network in which the mobile station operates, the method comprising the steps of:
a) measurement by the mobile station of a received power level on each channel among N different predetermined communication channels of the at least one wireless telephony cellular network, N being an integer greater than or equal to 7; and
b) location of the mobile station based on the levels measured in step a) and relevant predetermined information on the correspondence between received power level on each of the N channels and location within the given area.

8. The method according to claim 7, wherein:
for one or more given locations within the given area, the predetermined information comprises, for each given location, at least one associated set of W predetermined value(s) that is relevant on a received power level on each of the N channels in the corresponding given location, W being an integer greater than or equal to 1; and
step b) comprises locating the mobile station by analyzing the levels measured in step a) relative to the set(s) of W predetermined value(s).

9. The method according to claim 8, wherein:
W is equal to N, the W predetermined values of each set each being representative of a received power level on a respective channel among the N channels; and
the analysis in step b) comprises the comparison of the levels measured in step a) with the set(s) of W predetermined values.

10. The method according to claim 9, wherein the set(s) of W predetermined value(s) is/are the set(s) of N values from the first database created using a method comprising:
for one or more given locations within the given area, providing, for each of the given locations, at least one set of N values, each of the values corresponding to a measured reception power level on a respective channel among N different predetermined communication channels of the at least one wireless telephony cellular network, N being a fixed integer greater than or equal to 7; and
creating a first database associating each set of N values with the corresponding given measurement location.

11. The method according to claim 8, wherein:
W is less than N; and
the analysis in step b) comprises:
(i) applying W different predetermined function(s) to the levels measured in step a) to provide a set of W value(s) that is relevant of the levels measured in step a) homogenously with the set(s) of W predetermined value(s); and
(ii) comparing the set of W value(s) thus provided with the set(s) of W predetermined values.

12. The method according to claim 11, wherein the set(s) of W value(s) and the W predetermined function(s) are those provided, created, respectively, according to the method comprising at least one of:
(a) providing Q different function(s), Q being an integer greater than or equal to 1 and less than N; and
creating a second database from the first database by applying, to each set of N values, the Q function(s) to provide a corresponding set of Q value(s), the set of Q value(s) being associated in the second database with the corresponding given measurement location,
wherein the Q function(s) are chosen so that, for any pair of sets of N different values of the database, the two sets of Q values obtained by applying those Q functions to that pair of sets of N values are different from one another; or
(b) the Q function(s) are provided either through an analysis of primary components, or through an analysis of independent components; or
the Q function(s) respectively provide the average value, standard deviation, and other higher-order moments of the set of N values.

13. The method according to claim 7, wherein:
the predetermined information comprises:
for each one among one or more given locations within the given area, an associated set of R predetermined value(s) that is specific to that given location, R being an integer greater than or equal to 1; and
a set of R predetermined function(s) provided to supply, from the received power levels measured at any given location on the N channels and after any pre-processing of those measured levels, a set of R value(s) that is an approximation of the set of R predetermined value(s) corresponding to that given location; and
step b) comprises:
(i) providing a set of R value(s) using the set of R predetermined function(s) from the levels measured in step a) and preprocessed, if applicable; and
(ii) locating the mobile station by comparing the set of R supplied value(s) with the set(s) of R predetermined value(s).

14. The method according to claim 7, wherein:
the predetermined information comprises:
a set of R predetermined function(s) provided to supply, from received power levels, measured at any location within the given area, on the N channels and after any preprocessing of those measured levels, a set of R value(s) that is an approximation of the coordinates of the measurement location; and
step b) comprises:
(i) providing a set of R value(s) using the set of R predetermined function(s) from the levels measured in step a) and preprocessed, if applicable; and
(ii) locating the mobile station at the coordinates expressed by the set of R value(s) provided.

15. The method according to claim 7, wherein:
the predetermined information comprises:
a set of R predetermined function(s) provided to supply, from the received power levels, measured at any location within the given area, on the N channels and after any preprocessing of said measured levels, a set of R value(s) that is an approximation of the reference of the measurement location in a location referencing system within the given area; and
step b) comprises:
(i) supplying a set of R value(s) using the set of R predetermined function(s) from the levels measured in step a) and preprocessed if applicable; and
(ii) locating the mobile station at the location reference approximated by the supplied set of R value(s).

16. The method according to claim 13, wherein the set of R predetermined function(s) is determined by implementing;
for each one among one or more given locations within the given area, defining a set of R predetermined value(s) that is specific to that given location, R being an integer greater than or equal to 1, this set of R predetermined value(s) being associated with each set of N values provided for the corresponding given location in the first database; and
determining, by statistical learning from the first database, a set of R function(s) that can provide, from each set of N values, a set of R values that is an approximation of the set of R predetermined value(s) associated with said set of N values.

17. The method according to claim 7, wherein:
the predetermined information comprises:
for each among one or more given locations, an associated function provided to supply, from the received power levels measured on the N channels and after any preprocessing of those measured levels, an estimate of the probability that the measurement was done at the given location; and
step b) comprises locating the mobile station based on the probability estimate provided by all or part of the functions from the levels measured in step a) and preprocessed if applicable.

18. The method according to claim 17, wherein the function(s) are supplied using the method comprising:
for each given location, the determination, by statistical learning from either the first database or the second database, of a function able to provide, respectively from the set of N values or the set of Q value(s) obtained by applying the Q function(s) to the set of N values, an estimate of the probability that the measurement was done in that given location.

19. The method according to claim 13, wherein, in step (i), the levels measured in step a) are preprocessed by applying W different predetermined function(s), W being an integer greater than or equal to 1 and less than N.

20. The method according to claim 19, wherein the W function(s) are the Q function(s) supplied using the method comprising:
providing Q different function(s), Q being an integer greater than or equal to 1 and less than N; and
creating a second database from the first database by applying, to each set of N values, the Q function(s) to provide a corresponding set of Q value(s), the set of Q value(s) being associated in the second database with the corresponding given measurement location,
wherein the Q function(s) are chosen so that, for any pair of sets of N different values of the database, the two sets of Q values obtained by applying those Q functions to that pair of sets of N values are different from one another;
and the R predetermined function(s) are determined using the method comprising:
for each one among one or more given locations within the given area, the definition of a set of R predetermined value(s) that is specific to that given location, R being an integer greater than or equal to 1, this set of R predetermined value(s) being associated with each set of Q values provided for the corresponding given location in the second database; and
determining, by statistical learning from the second database, a set of R function(s) that can provide, from each set of Q value(s), a set of R value(s) that is an approximation of the set of R predetermined value(s) associated with said set of Q value(s).

21. The method according to claim 7, further comprising locating the mobile station inside one or more buildings.

22. The method according to claim 7, wherein the predetermined information is established based on received power measurements taken on the N channels at different locations within the given area with the same mobile station that is to be located.

23. The method according to claim 1, wherein N is greater than or equal to 20.

24. Software for a mobile station provided to operate in at least one wireless telephony cellular network, the software being provided to have the mobile station carry out the location method according to claim 7.

25. A computer software application, stored in non-transient memory, provided to have a computer implement the following steps:
a) reception by the computer of a measurement done by a mobile station of the received power level on each channel among N different predetermined communication channels of at least one wireless telephony cellular network, N being an integer greater than or equal to 7; and
b) locating the mobile station based on the received power level measured and relevant predetermined information on the correspondence between the received power level on each of the N channels and location within the given area.

26. A mobile station that can operate in at least one wireless telephony cellular network, which is provided to carry out the location method according to claim 7.
